(19) United States
(12) Patent Application Publication
(10) Pub. No.: US 2008/0009319 A1
(43) Pub. Date: Jan. 10, 2008

(54) MULTICAST AND BROADCAST SERVICE (MBS) APPARATUS AND METHOD IN BROADBAND WIRELESS ACCESS (BWA) SYSTEM

(75) Inventors: Jun-Hyung KIM, Suwon-si (KR); Nae-Hyun Lim, Yongin-si (KR); Hae-Jung Lim, Seoul (KR); Yong Chang, Seongnam-si (KR); Jin-Han Song, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/774,866

(22) Filed: Jul. 9, 2007

(30) Foreign Application Priority Data
Jul. 7, 2006 (KR) 2006-0063774

(51) Int. Cl. H04B 1/38; H04M 1/00

(52) U.S. Cl. 455/560

(57) ABSTRACT

A Multicast and Broadcast Service (MBS) apparatus and method in a Broadband Wireless Access (BWA) system are provided. The method for providing a broadcast service in the BWA system includes requesting, at MBSC, allocation of MBS bursts by transmitting a profile number to BS; and acquiring, at the BS, MBS burst information by accessing to a profile table using the profile number received from the MBSC.

### PRIORITY

This application claims priority under 35 U.S.C. § 119(a) to an application filed in the Korean Intellectual Property Office on Jul. 7, 2006 and assigned Serial No. 2006-63774, the contents of which are herein incorporated by reference.

### BACKGROUND OF THE INVENTION

1. Field of the Invention

The present invention relates generally to a Multicast and Broadcast Service (MBS) apparatus and method in a Broadband Wireless Access (BWA) system, and in particular, to a profile based burst-scheduling apparatus and method in a BWA system.

2. Description of the Related Art

In general, the development of communication systems has been centered on voice services and is now advancing to data services and various multimedia services as well as the voice services. However, the voice oriented communication system, which has less transmission bandwidth and higher fees, has not satisfied increasing service needs of users. In addition, with the advance of communication industry and the increasing user demand for Internet service, there is a great demand for a communication system capable of efficiently providing the Internet service. To respond to this, a Broadband Wireless Access (BWA) system is introduced to provide a broadband connection with enough bandwidth to satisfy the increasing demand of the users and to efficiently provide the Internet service.

The BWA system integrally supports not only voice but also multimedia application services, such as various low and high-speed data services and high-definition videos. The BWA system is a radio communication system capable of accessing the Public Switched Telephone Network (PSTN), the Public Switched Data Network (PSDN), the Internet, a IMT2000 network, an Asynchronous Transfer Mode (ATM) network, etc. in mobile or stationary environments based on a radio medium using the broad band such as 2 GHz, 5 GHz, 26 GHz, and 60 GHz, and supporting a channel transfer rate above 2 Mbps. Based on the terminal mobility (fixed or stationary), the communication environment (indoor or outdoor), and the channel transfer rate, the BWA system can be classified into a broadband wireless subscriber network, a broadband mobile access network, and a high-speed wireless Local Area Network (LAN).

The wireless access scheme of the BWA system is standardized by the Institute of Electrical and Electronics Engineers (IEEE) 802.16 Working Group, which is an international standardization organization.

Compared to a conventional wireless technology for the voice service, the IEEE 802.16 standard can transfer more data within a shorter time using the wide data bandwidth and efficiently utilize a channel by sharing the channel (or resources) by all users. Also, by guaranteeing Quality Of Service (QoS), users can enjoy services of different qualities according to the service characteristics.

The IEEE 802.16 system includes a Multicast and Broadcast Service (MBS) specification for providing the multicast and the broadcast to a plurality of Mobile Stations (MSs). The MBS specification can distinguish multicast and broadcast service zones using different Connection IDentifiers (CIDs) or different Security Associations (SAs). Namely, an MBS zone MBS_ZONE can be distinguished using CID and SA. A Base Station (BS) broadcasts MBS_ZONE information using a Downlink Channel Descriptor (DCD) message. In other words, it can be said that the MBS_ZONE is BS group that uses the same CID and SA to transmit contents.

The MBS service is divided into single-BS access and multi-BS access based on the service access method of the MS. In the single-BS access scheme, the MS receives the MBS service from a single BS to which the MS is registered. In the multi-BS access scheme, the MS receives the MBS service from two or more BSs at the same time. FIG. 1 illustrates the single-BS access scheme and FIG. 2 illustrates the multi-BS access scheme.

In the multi-BS access scheme of FIG. 2, when an MS is positioned in the overlapping area between a current service cell and an adjacent cell, a signal of the adjacent cell acts as a signal gain by Radio Frequency (RF) combining, rather than as noise by interference. This is the macro diversity effect. However, to obtain the macro diversity effect, the signal from the BS in service should be identical to the signal from the BS of the adjacent cell. Accordingly, to provide the MBS, every BS within the MBS_ZONE needs to transmit the same signal at the same time point.

As discussed above, to provide the MBS, a new burst-scheduling scheme is required to support the same transmission of a plurality of BSs.

### SUMMARY OF THE INVENTION

An aspect of the present invention is to substantially solve at least the above problems and/or disadvantages and to provide at least the advantages below. Accordingly, an aspect of the present invention is to provide a burst-scheduling apparatus and method for MBS in a BWA communication system.

Another aspect of the present invention is to provide an apparatus and method for performing MBS burst-scheduling based on a profile in a BWA communication system.

A further aspect of the present invention is to provide an apparatus and method for allocating MBS bursts in a BWA communication system.

A further aspect of the present invention is to provide an apparatus and method for a BS in the same zone to perform an MBS using bursts determined based on a profile in a BWA communication system.

A further aspect of the present invention is to provide an apparatus and method for reserving a certain area of frames of BSs in the same zone as MBS bursts in a BWA communication system.

The above aspects are achieved by providing a communicating method of a Multicast and Broadcast Service Controller (MBSC) in a BWA system, which includes selecting a profile number according to a broadcast schedule by accessing a profile selection table, which manages broadcast channel information serviceable from a BS; and transmitting the selected profile number to the BS.

According to one aspect of the present invention, a communicating method of a BS in a BWA system includes setting a profile table relating to an MBS; and acquiring MBS burst information by accessing to the profile table using a profile number provided from an MBS Controller (MBSC).

According to another aspect of the present invention, a method for providing a broadcast service in a BWA system includes requesting, at an MBSC, allocation of MBS bursts by transmitting a profile number to a BS; and acquiring, at the BS, MBS burst information by accessing to a profile table using the profile number received from the MBSC.

According to a further aspect of the present invention, a communicating apparatus of an MBSC in a BWA system includes a storage for storing a profile selection table, which manages broadcast channel information serviceable by a BS; and a controller for selecting a profile number according to a broadcast schedule by accessing the profile selection table and transmitting the selected profile number to the BS.

According to a further aspect of the present invention, a communicating apparatus of a BS in a BWA system includes a storage for storing a profile table relating to an MBS; and a controller for acquiring MBS burst information by accessing the profile table using a profile number provided from an MBSC.

According to a further aspect of the present invention, an apparatus for providing a broadcast service in a BWA system includes an MBSC for storing a profile selection table, which holds broadcast channel information serviceable by a BS, selecting a profile number according to a broadcast schedule using the profile selection table, and transmitting the profile number to the BS; and the BS for storing a profile table relating to an MBS, and acquiring MBS burst information by accessing the profile table using the profile number received from the MBSC.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a single-BS access scheme according to MBS;

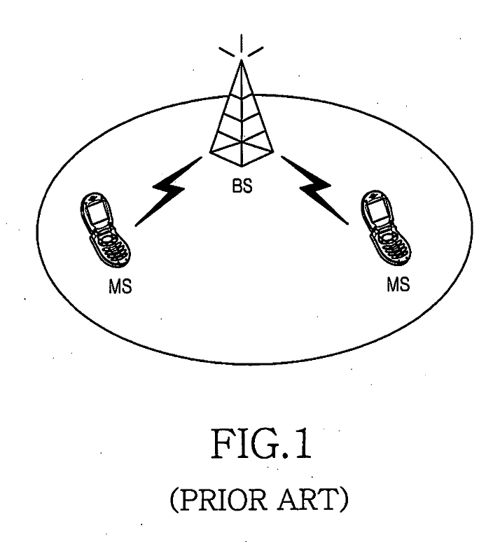

FIG. 2 illustrates a multi-BS access scheme according to MBS;

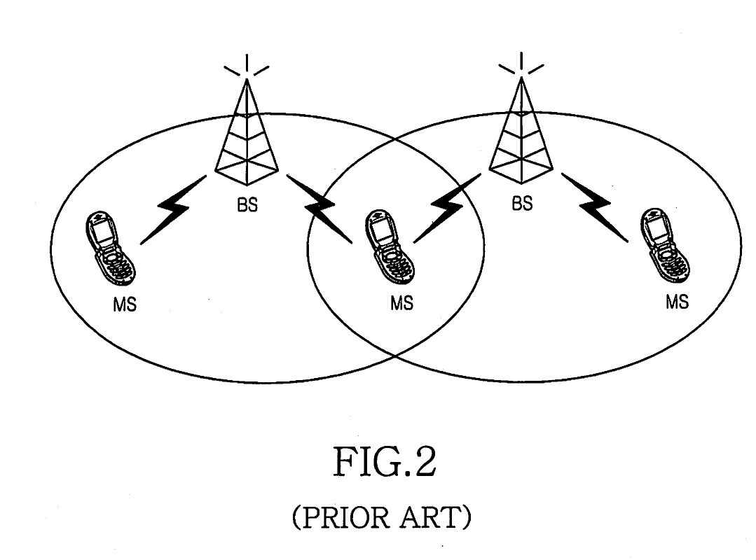

FIG. 3 illustrates a frame structure for MBS of two adjacent BSs to acquire macro diversity effect according to the present invention;

FIG. 4 illustrates a network structure for providing MBS according to the present invention;

FIG. 5 illustrates a frame structure of BS scheduled by MBSC according to the present invention;

FIG. 6 is a detailed block diagram of the MBSC according to the present invention;

FIG. 7 is a detailed block diagram of the BS according to the present invention;

FIG. 8 is a flowchart of operations of the MBSC according to the present invention; and

FIG. 9 is a flowchart of operations of the BS according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a burst-scheduling method for a Multicast and Broadcast Service (MBS) in a Broadband Wireless Access (BWA) communication system.

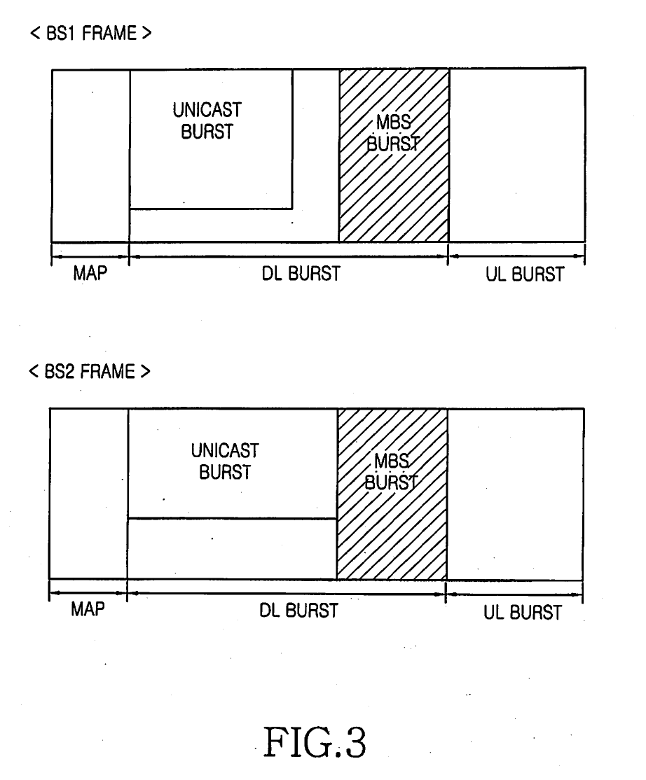

FIG. 3 illustrates a frame structure for the MBS of two adjacent Base Stations (BSs) to attain a macro diversity effect according to the present invention.

As shown in FIG. 3, to attain the macro diversity effect, location and size of bursts for the MBS broadcasting and its transmission timing of a BS1 and a BS2 should be exactly the same. For example, burst information for the MBS can be constructed by including an Orthogonal Frequency Division Multiple Access (OFDMA) symbol offset, a subchannel offset, boosting, a number of OFDMA symbols, a number of subchannels, and a repetition coding indication. Hence, those fields of the bursts transmitted by the two BSs need to correspond with each other.

As above, since all BSs in one MBS_ZONE transmitting the same broadcasting need to have exactly the same location, size, and transmission timing of the MBS bursts, an MBS Controller (MBSC), which performs the broadcasting related control at the higher level, should schedule the burst information. In other words, the MBSC needs to collectively allocate and manage bursts for the MBS among frames broadcast by all BSs in its managing MBS_ZONE.

Detailed embodiments are illustrated by referring to the drawings.

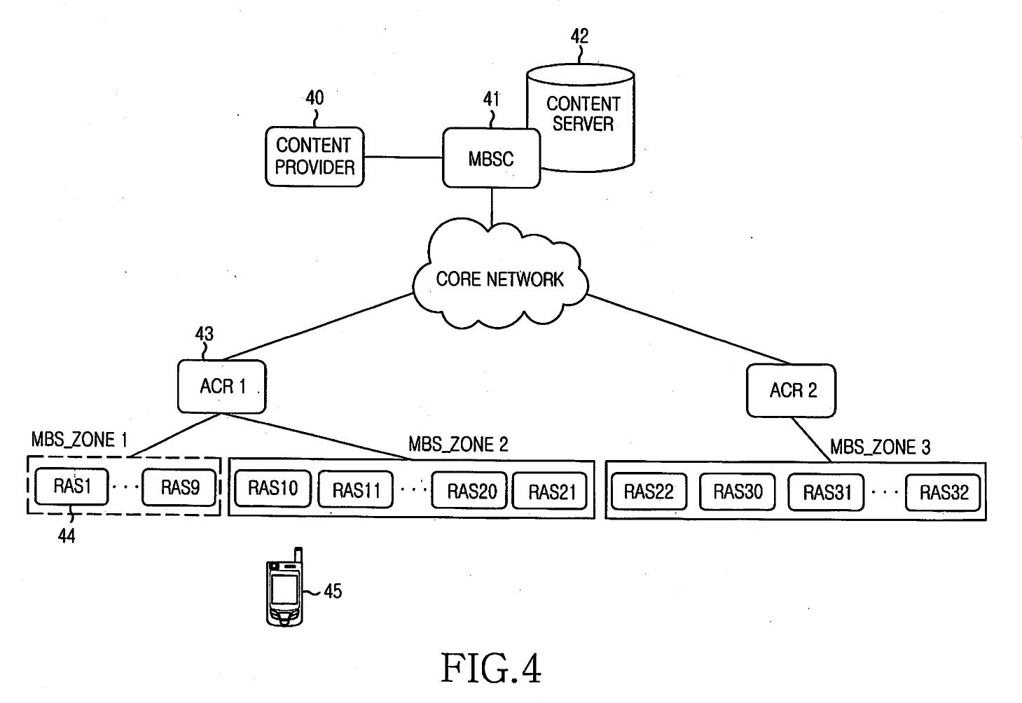

FIG. 4 illustrates a network structure for providing MBS according to the present invention.

The network structure of FIG. 4 includes a content provider 40, an MBSC 41, a content server 42, a BS controller 43, a BS 44, and a Mobile Station (MS) 45. For example, the BS 44 can be a Radio Access Station (RAS). The BS controller 43 can be an Access Control Router (ACR) or an Access Service Network-GateWay (ASN-GW). Herein, the ASN-GW can function as not only the BS controller but also a router. The MBSC 41 can be placed in the BS controller 43 in the actual implementation.

In FIG. 4, the content provider 40 generates and provides MBS contents to the MBSC 41. The MBSC 41 stores the contents provided from the content provider 40 to the content server 42. According to a broadcast schedule, the MBSC 41 receives corresponding contents from the content server 42 and transmits the contents to the MS 45 via the BS controller 43 and the BS 44. The BS 44 wirelessly communicates with the MS 45, and forwards contents from the BS controller 43 to the MS 45. The BS controller 43 receives contents from the MBSC 41 and forwards the received contents to the BS 44. As shown in FIG. 4, one MBS_ZONE includes a plurality of BSs, and the BSs in the same MBS_ZONE transmit the same broadcast signal at the same time.

With the construction of FIG. 4, operations according to the present invention are now illustrated.

It is assumed that there are four channels (channels 1, 2, 3 and 4) in MBS_ZONE 2 managed by the MBSC 41. For doing so, the MBSC 41 reserves part of frames of every BS in the MBS_ZONE to use it as bursts for the MBS. Next, the MBSC 41 divides and allocates the reserved MBS bursts for the four channels, respectively.

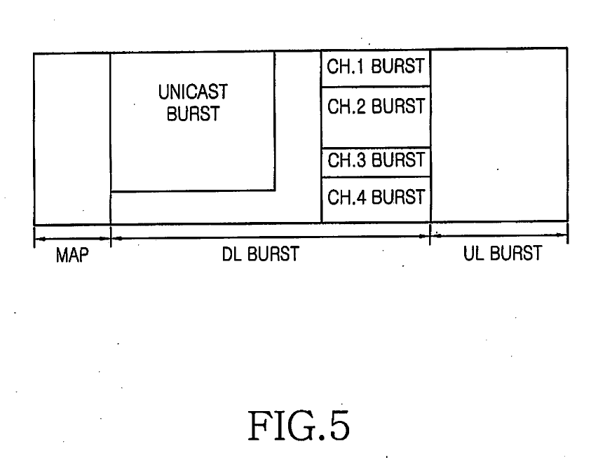

FIG. 5 illustrates BS frame structure scheduled by the MBSC 41 according to the present invention. As shown in FIG. 5, part of DownLink (DL) subframes of a frame are allocated for MBS bursts, and the MBS bursts are divided to bursts for respective channels. The burst information allocated for the respective channels can include an OFDMA symbol offset, a subchannel offset, boosting, a number of OFDMA symbols, a number of subchannels, and a repetition coding indication.

According to the present invention, parameter sets are generated by content programs for the MBS burst allocation and arranged as profiles. The MBSC 41 selects a profile number suitable for a broadcast schedule based on a profile selection table as shown in Table 1, and provides the selected profile number to the BS 44.

TABLE 1

| | Channel information | |
|---|---|---|
| Profile number | Video channel (300 kbps) | Audio channel (50 kbps) |
| 1 | 4 | 5 |
| 2 | 4 | 3 |
| 3 | 3 | 3 |
| . . . | . . . | . . . |
| 16 | 2 | 0 |

The BS 44 holds a profile table as shown in Table 2, and performs the MBS burst allocation based on the profile number provided from the MBSC 41. That is, BSs receiving the same profile number in the same zone allocate the same bursts for the MBS.

TABLE 2

| Profile | U:M | MBS | Channel information | |
|---|---|---|---|---|
| number | ratio | burst | Video channel | Audio channel |
| 1 | 1:1 | burst | number of channels: 4 | number of channels: 5 |
| | | info | channel1: burst1 info | channel1: burst1 info |
| | | | cbannel2: burst2 info | channel2: burst2 info |
| | | | channel3: burst3 info | channel3: burst3 info |
| | | | channel4: burst4 info | channel4: burst4 info |
| | | | | channel5: burst5 info |
| 2 | 1:1 | burst | number of channels: 4 | number of channels: 3 |
| | | info | channel1: burst1 info | channel1: burst1 info |
| | | | channel2: burst2 info | channel2: burst2 info |
| | | | channel3: burst3 info | channel3: burst3 info |
| | | | channel4: burst4 info | |
| 3 | 2:1 | burst | number of channels: 3 | number of channels: 3 |
| | | info | channel1: burst1 info | channel1: burst1 info |
| | | | channel2: burst2 info | channel2: burst2 info |
| | | | channel3: burst3 info | channel3: burst3 info |
| . . . | . . . | . . . | . . . | . . . |
| 16 | 4:1 | burst | number of channels: 2 | number of channel: 0 |
| | | info | channel1: burst1 info | |
| | | | channel2: burst2 info | |

While it is assumed that the number of profiles is 16 in Table 2, the number of profiles may increase or decrease depending on the channel information and the schedule. U:M ratio indicates a ratio of unicast bursts to multicast bursts in the DL subframes of one frame transmitted by BS. For instance, in case of 4:1, when the total DL subframes are 20 symbols, the multicast bursts occupy 4 symbols. MBS burst is information indicative of the size and the location of MBS burst allocated for the broadcasting, which is transmitted from the MBSC 41, in the multicast area. Channel information is information relating to contents actually transmitted by the MBSC 41.

When there are seven channels in the broadcast program in total, of which four channels are video channels and three channels are music channels, the MBSC 41 selects and transmits the profile No.2 to the BS 44. Although only two channels of the video channel requiring the band 300 Kbps and the audio channel requiring the band 50 Kbps are illustrated, the video channel can be segmented by bandwidths. That is, the video channel can be divided to a video channel for High Definition (HD) broadcast and a video channel for Standard Definition (SD) broadcast. Depending on the number of channels, the BS 44 divides the MBS bursts for the broadcasting and allocates the bursts for the respective channels.

The profile table of Table 2 is generated and managed by the BS 44, and all BSs in the MBS_ZONE share the same table. In specific, the U:M ratio, and the location and the size of the entire bursts for the MBS are determined based on the profile number. Burst information for each channel is predefined. Thus, the BS 44 allocates the MBS bursts according to the profile number provided from the MBSC 41, and then services the contents provided from the MBSC 41 to the MS 45 using the pre-allocated MBS bursts.

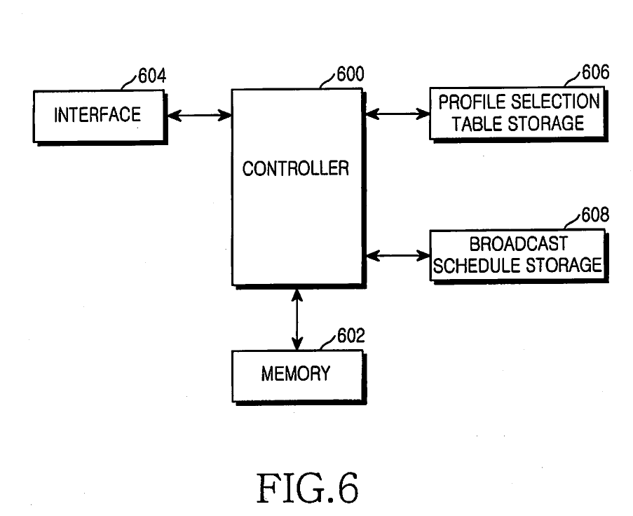

FIG. 6 is a detailed block diagram of the MBSC 41 according to the present invention.

The MBSC 41 of FIG. 6 includes a controller 600, a memory 602, an interface 604, a profile selection table storage 606, and a broadcast schedule storage 608.

The controller 600 in FIG. 6 controls overall operation of the MSBC 41. The memory 602 stores programs for controlling the operations of the MSBC 41 and data generated during program execution. The interface 604 generates and decomposes packets interfaced with another network entity.

The controller 600 generates a broadcast schedule using content attribute information provided from the content provider 40 and detailed attribute information of the BWA system, which is collected from an RAS/ACR, and stores the generated broadcast schedule to the broadcast schedule storage 608. The controller 600 stores the profile selection table (Table 1) received from the RAS/ACR to the profile selection table storage 606. The controller 600 selects a profile number suitable for the broadcast schedule by accessing the profile selection table, and transmits the selected profile number to the corresponding BS (RAS). Next, the controller 600 receives contents from the content server 42 according to the broadcast schedule and transmits the contents to the BS (RAS).

Now, a structure of a BS, which allocates bursts using the profile number is explained.

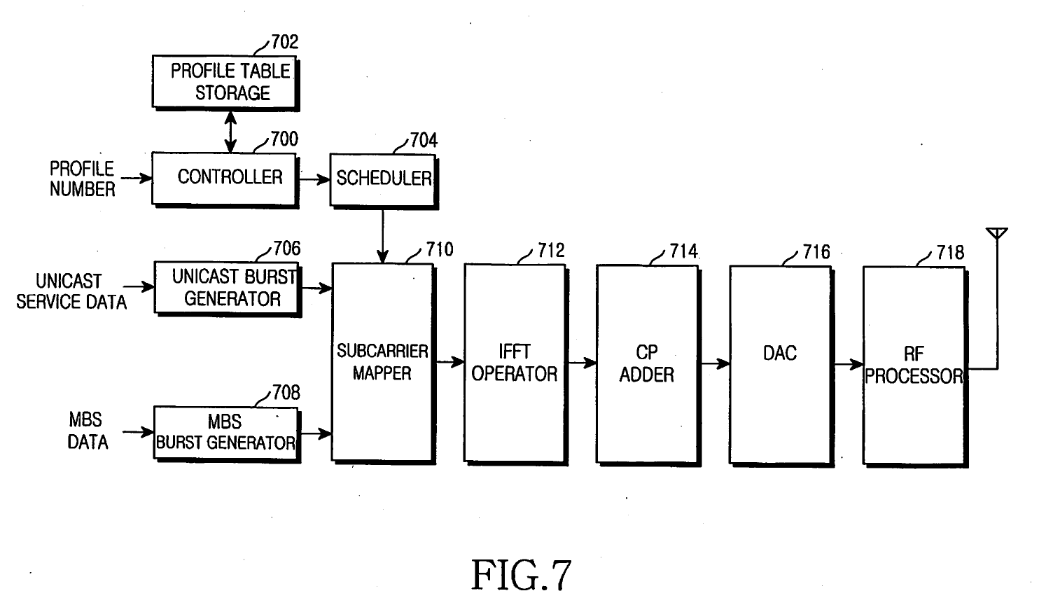

FIG. 7 is a detailed block diagram of the BS 44 according to the present invention.

The BS of FIG. 7 includes a controller 700, a profile table storage 702, a scheduler 704, a unicast burst generator 706, an MBS burst generator 708, a subcarrier mapper 710, an Inverse Fast Fourier Transform (IFFT) operator 712, a Cyclic Prefix (CP) adder 714, a Digital-to-Analog Converter (DAC) 716, and a Radio Frequency (RF) processor 718.

The controller 700 of FIG. 7 receives the profile number from the MBSC 41 and acquires profile information relating to the MBS bursts by accessing to the profile table (Table 2) stored to the storage 702 with the profile number. As shown in Table 2, the profile information can be the U:M ratio, the allocation information relating to the MBS bursts, and the burst allocation information relating to the respective channels configured in the MBS burst. The acquired profile information is provided to the scheduler 704.

The scheduler 704 schedules resources using the MBS profile information provided from the controller 700 and other factors (e.g., channel information, service type, etc), and controls the corresponding component according to the scheduling result.

The unicast burst generator 706 generates and outputs unicast bursts with the input unicast service data. Herein, the unicast burst generator 706 constitutes physical layer bursts by collecting Media Access Control (MAC) Protocol Data Units (PDUs), codes and modulates the bursts of the MAC layer at a Modulation and Coding Scheme (MSC) level according to the scheduling result.

The MBS burst generator 708 generates and outputs MBS bursts (broadcast channel bursts) with the MBS data (broadcast contents) provided from the MBSC 41. Herein, the MBS burst generator 708 constitutes physical layer burst by collecting MAC PDUs, codes and modulates the bursts of the MAC layer at MSC level according to the scheduling result.

The subcarrier mapper 710 maps the input unicast bursts and the MBS bursts to subcarriers under the control of the scheduler 704 and outputs the mapped bursts. According to the present invention, the MBS bursts are mapped into a domain (time-frequency domain) based on the profile number fed from the MBSC 41 and then output.

The IFFT operator 712 outputs time-domain data by IFFT-processing the data fed from the subcarrier mapper 710. The CP adder 714 appends a guard interval to the data fed from the IFFT operator 712 and then outputs the data. The DAC 716 converts sample data fed from the CP adder 714 to an analog signal and outputs the analog signal. The RF processor 718 converts a baseband signal fed from the DAC 716 to an RF signal and transmits the RF signal over an antenna.

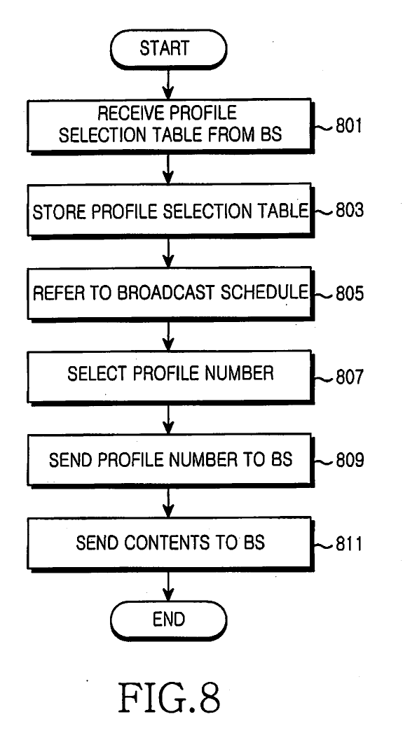

FIG. 8 is a flowchart of operations of the MBSC 41 according to the present invention.

Referring to FIG. 8, the MBSC 41 receives the profile selection table (Table 1) from a certain BS 44 in step 801, and stores the received profile selection table in step 803. As shown in Table 1, the profile selection table contains profile numbers and brief broadcast channel information corresponding to the profile numbers. Depending on the operation scheme, the profile selection table can be provided from the BS or input by an operator (or network manager).

After storing the profile selection table, the MBSC 41 checks the pre-stored broadcast schedule in step 805, and selects a profile number suitable for the broadcast schedule by accessing the profile selection table in step 807.

In step 809, the MBSC 41 transmits the selected profile number to the BS 44. After sending the profile number, the MBSC 41 receives contents according to the broadcast schedule from the content server 42 and forwards the received contents to the BS 44 in step 811. MBS bursts according to the profile number are retained during a validity period of the broadcast schedule. In other words, when the broadcast schedule is updated, the MBSC 41 reselects a profile number and transmits the changed profile number to the BS 44 to reserve the MBS bursts.

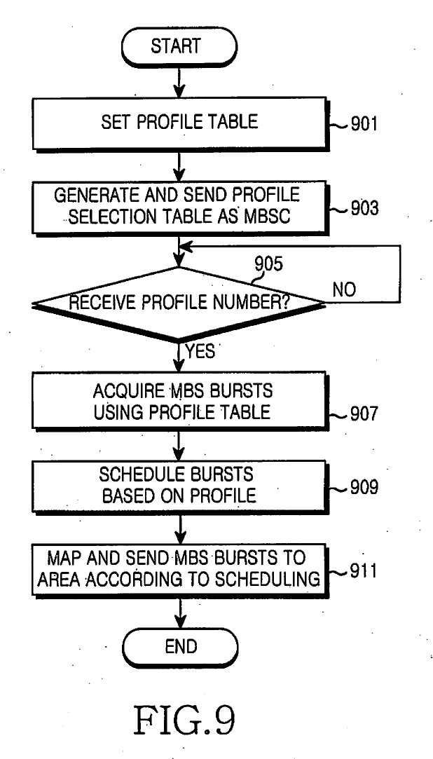

FIG. 9 is a flowchart of operations of the BS 44 according to the present invention.

The BS 44 of FIG. 9 sets the broadcast profile table (Table 2) according to the input from an operator (or a network manager) in step 901. Next, the BS 44 generates the profile selection table (Table 1) based on the profile table and transmits the generated profile selection table to the MBSC 41 in step 903.

As described earlier, the broadcast profile table contains the U:M ratio, the allocation information of the MBS bursts, and the burst allocation information of the respective channels configured in the MBS bursts. The profile selection table contains the profile numbers and the brief broadcast channel information corresponding to the profile numbers. Depending on the operation scheme, the profile selection table can be provided from the BS 44 to the MBSC 41, or set at the MBSC 41 directly by the operator.

After sending the profile selection table, the BS 44 examines whether a profile number is received from the MBSC 41 in step 905. When receiving the profile number, the BS 44 acquires profile information relating to the MBS bursts by accessing the profile table with the profile number in step 907.

After acquiring the profile information, the BS 44 performs the burst-scheduling (or the resource scheduling) using the profile information in step 909. In step 911, the BS 44 transmits the MBS bursts to MS by mapping the MBS bursts carrying contents from the MBSC 41 to areas (or resources) according to the scheduling result. In the mean time, the MBS bursts based on the profile number are maintained during the validity period of the broadcast schedule, and the MBS bursts are re-allocated when the changed profile number is received from the MBSC 41.

In light of the foregoing, the present invention provides the burst-scheduling method for the MBS when providing the MBS in the BWA system. The MBSC can easily schedule the broadcast services using the MBS profile predefined at the BS even when the MBSC does not know the burst allocation information of the BS at first hand. Additionally, since the MBSC and the BS merely exchange the profile number for the sake of the burst-scheduling, it is possible to reduce the network overload (or signaling overload).

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A communicating method of a Multicast and Broadcast Service Controller (MBSC) in a Broadband Wireless Access (BWA) system, the method comprising:
selecting a profile number according to a broadcast schedule by accessing a profile selection table, which manages broadcast channel information serviceable from a Base Station (BS); and
transmitting the selected profile number to the BS.

2. The communicating method of claim 1, wherein the profile selection table stores a mapping relation between profile numbers and the broadcast channel information.

3. The communicating method of claim 1, further comprising:
when the broadcast schedule is updated, re-acquiring the profile number using the profile selection table; and
transmitting the acquired profile number to the BS.

4. The communicating method of claim 1, wherein the profile selection table is received from the BS or set by an operator.

5. The communicating method of claim 1, further comprising:
after transmitting the profile number, transmitting contents according to the broadcast schedule to the BS.

6. A communicating method of a Base Station (BS) in a Broadband Wireless Access (BWA) system, the method comprising:
setting a profile table relating to a Multicast and Broadcast Service (MBS); and
acquiring MBS burst information by accessing the profile table using a profile number provided from an MBS Controller (MBSC).

7. The communicating method of claim 6, further comprising:
performing a resource scheduling using the acquired MBS burst information.

8. The communicating method of claim 6, wherein the profile table, with respect to each profile number, includes at least one of a ratio of unicasts to multicasts, allocation information of MBS bursts, and burst allocation information for respective broadcast channels constituted in the MBS bursts.

9. The communicating method of claim 6, further comprising:
generating MBS bursts with contents provided from the MBSC;
mapping the generated MBS bursts to MBS burst resources corresponding to the profile number; and
converting the mapped data to a Radio Frequency (RF) signal and transmitting the RF signal.

10. The communicating method of claim 6, further comprising:
generating a profile selection table based on the profile table, and transmitting the profile selection table to the MBSC.

11. A method for providing a broadcast service in a Broadband Wireless Access (BWA) system, the method comprising:
requesting, at a Multicast and Broadcast Service Controller (MBSC), an allocation of MBS bursts by transmitting a profile number to a Base Station (BS); and
acquiring, at the BS, MBS burst information by accessing a profile table using the profile number received from the MBSC.

12. The method of claim 11, further comprising:
setting, at the MBSC, a profile selection table, which stores a mapping relation between profile numbers and broadcast channel information.

13. The method of claim 12, wherein the requesting step comprises:
selecting a profile number according to a broadcast schedule by accessing the profile selection table; and
transmitting the selected profile number to the BS.

14. The method of claim 13, further comprising:
when the broadcast schedule is updated, re-acquiring, at the MBSC, the profile number using the profile selection table and transmitting the acquired profile number to the BS.

15. The method of claim 12, wherein the profile selection table is received from the BS or set by an operator.

16. The method of claim 11, wherein the profile table, with respect to each profile number, stores at least one of a ratio of unicasts to multicasts, allocation information of MBS bursts, and burst allocation information for respective broadcast channels configured in the MBS bursts.

17. The method of claim 13, further comprising:
transmitting, at the MBSC, contents according to the broadcast schedule to the BS.

18. The method of claim 17, further comprising:
mapping, at the BS, contents provided from the MBSC to resources according to the acquired MBS burst information and transmitting the mapped contents.

19. The method of claim 12, further comprising:
generating, at the BS, the profile selection table based on the profile table and transmitting the profile selection table to the MBSC.

20. A communicating apparatus of a Multicast and Broadcast Service Controller (MBSC) in a Broadband Wireless Access (BWA) system, comprising:
a storage for storing a profile selection table, which manages broadcast channel information serviceable by a Base Station (BS); and
a controller for selecting a profile number according to a broadcast schedule by accessing the profile selection table and transmitting the selected profile number to the BS.

21. The communicating apparatus of claim 20, wherein the profile selection table stores a mapping relation between profile numbers and the broadcast channel information.

22. The communicating apparatus of claim 20, wherein, when the broadcast schedule is updated, the controller re-acquires the profile number using the profile selection table and transmits the acquired profile number to the BS.

23. The communicating apparatus of claim 20, wherein the profile selection table is received from the BS or set by an operator.

24. The communicating apparatus of claim 20, wherein the controller transmits contents according to the broadcast schedule to the BS.

25. A communicating apparatus of a Base Station (BS) in a Broadband Wireless Access (BWA) system, comprising:
a storage for storing a profile table relating to a Multicast and Broadcast Service (MBS); and
a controller for acquiring MBS burst information by accessing the profile table using a profile number provided from an MBS Controller (MBSC).

26. The communicating apparatus of claim 25, further comprising:
a scheduler for performing a resource scheduling using the MBS burst information provided from the controller.

27. The communicating apparatus of claim 25, wherein the profile table, with respect to each profile number, stores at least one of a ratio of unicasts to multicasts, allocation information of MBS bursts, and burst allocation information for respective broadcast channels configured in the MBS bursts.

28. The communicating apparatus of claim 25, further comprising:
a generator for generating MBS bursts with contents provided from the MBSC;
a subcarrier mapper for mapping the MBS bursts fed from the generator to a resource corresponding to the profile number;
an Inverse Fast Fourier Transform (IFFT) operator for generating time-domain data by IFFT-processing data fed from the subcarrier mapper; and
a transmitter for converting data fed from the IFFT operator to a Radio Frequency (RF) signal and transmitting the RF signal.

29. The communicating apparatus of claim 25, wherein the controller generates a profile selection table based on the profile table and transmits the profile selection table to the MBSC.

30. An apparatus for providing a broadcast service in a Broadband Wireless Access (BWA) system, comprising:
a Multicast and Broadcast Service Controller (MBSC) for storing a profile selection table, which holds broadcast channel information serviceable by a Base Station (BS), selecting a profile number according to a broadcast schedule using the profile selection table, and transmitting the profile number to the BS; and
the BS for storing a profile table relating to a Multicast Broadcast Service (MBS), and acquiring MBS burst information by accessing the profile table using the profile number received from the MBSC.

31. The apparatus of claim 30, wherein the profile selection table stores a mapping relation between profile numbers and the broadcast channel information.

32. The apparatus of claim 30, wherein, when the broadcast schedule is updated, the MBSC re-acquires the profile number using the profile selection table and transmits the acquired profile number to the BS.

33. The apparatus of claim 30, wherein the profile selection table is received from the BS or set by an operator.

34. The apparatus of claim 30, wherein the profile table, with respect to each profile number, stores at least one of a ratio of unicasts to multicasts, allocation information of MBS bursts, and burst allocation information for respective broadcast channels configured in the MBS bursts.

35. The apparatus of claim 30, further comprising:
a content server for storing broadcast contents,
wherein the MBSC acquires contents according to the broadcast schedule from the content server and transmits the contents to the BS.

36. The apparatus of claim 35, wherein the BS maps and transmits the contents from the MBSC to resources according to the acquired MBS burst information.

37. The apparatus of claim 30, wherein every BS in an MBS zone to which the BS belongs has the same profile table, and every BS in the MBS zone transmits the same signal at the same time according to the same profile number from the MBSC.

38. The apparatus of claim 30, wherein the BS generates the profile selection table based on the profile table and transmits the profile selection table to the MBSC.

39. A communication method of Base Station (BS) in wireless communication system, the method comprising:
receiving profile index from a Multicast and Broadcast Service Controller (MBSC).
acquiring burst allocation information for broadcast channels by accessing to the profile table using a profile index.

40. The communication method of claim 39, further comprising:
performing a resource scheduling using the acquired burst allocation information.

41. The communication method of claim 39, further comprising:
generating MBS burst with contents received from the MBSC.
mapping the generated MBS Burst to resource corresponding to the burst allocation information.
transmitting the mapped MBS burst.
